(19) United States
(12) Patent Application Publication
(10) Pub. No.: US 2015/0244591 A1
(43) Pub. Date: Aug. 27, 2015

(54) Power Management in Local Premise Networks

(71) Applicant: INVENT.LY LLC, Woodside, CA (US)

(72) Inventor: Stephen J. Brown, Woodside, CA (US)

(73) Assignee: INVENT.LY LLC, Woodside, CA (US)

(21) Appl. No.: 14/186,581

(22) Filed: Feb. 21, 2014

(51) Int. Cl. H04L 12/26; H04L 12/911

(52) U.S. Cl. CPC H04L 43/04; H04L 47/74

(57) ABSTRACT

A router has a processor, a data repository, wired connection or wireless coupling to individual ones of a plurality of power-using devices in a local premise, the router and the power-using devices drawing power from a primary source, and individual ones of the router and the power-using devices having switchable access to one or more alternative power sources, an Internet access connection, and software executing on the processor from a non-transitory medium. The software provides monitoring power provided by the primary source to the router and to individual ones of the power-using devices, receiving information regarding the primary power source from one or more network-connected servers, determining expected status of the primary power source by the software using the monitoring information and the information received from the Internet, and managing power usage by the router and the power-using devices according to the expected status determined.

### BACKGROUND OF THE INVENTION

1. Field of the Invention

The present invention is in the field of smart premise technology and pertains particularly to methods and apparatus for predicting future power availability for individual ones of smart networks and appliances, including managing power options among multiple power-consuming appliances within the networks.

2. Discussion of the State of the Art

With the advent of the Internet and of relatively seamless communications capabilities that now exist between sub-networks of the Internet, including communications carrier networks, service providers are marketing smart technologies that bundle different types of digital services that may be delivered through a single premise network router or hub. The fact that a single router or hub may efficiently handle all of the communications and media routing to appropriate end appliances local to the router helps to reduce or otherwise streamline the complexity of many smart premise networks.

There is, however, a drawback in bundling all services to use one conventional network router for communication. The local premise network becomes vulnerable to lack of power or intermittent power and bandwidth loss, which can result in idling of digital services running alone or in tandem with other services. With power availability being unstable or otherwise not consistent in both urban and rural environments, it has occurred to the inventor that clients using smart technologies, including bundled communications and media services, would benefit if potential loss or degradation of power could be predicted.

Therefore, what is clearly needed is a smart premise networking system that utilizes multiple types of input and collected data from disparate sources to predict potential power loss and degradation issues facing a smart premise network, and that manages multiple power-consuming devices and power supply options connected to the network accordingly.

### BRIEF SUMMARY OF THE INVENTION

In one embodiment of the invention a router is provided, comprising a processor, a data repository, wired connection or wireless coupling to individual ones of a plurality of power-using devices in a local premise, the router and the power-using devices drawing power from a primary source, and individual ones of the router and the power-using devices having switchable access to one or more alternative power sources, an Internet access connection, and software executing on the processor from a non-transitory medium, execution of the software providing monitoring power provided by the primary source to the router and to individual ones of the power-using devices, receiving information regarding the primary power source from one or more network-connected servers, determining expected status of the primary power source by the software using the monitoring information and the information received from the Internet, and managing power usage by the router and the power-using devices according to the expected status determined.

In one embodiment, in the step for determining expected status, a status is selected from a plurality of preprogrammed status levels, ranging from reliable power to complete interruption of the primary source. Also in one embodiment the software provides an interactive interface to a user accessing the router through the Internet network or by WIFI connection, enabling the user to configure the functions of the software for power-management activity. Also in one embodiment, in the step for managing power usage, power to individual ones of the power-using devices is shut off or diverted to an alternative power source as a result of status changing from fully reliable primary power to a different status level.

Still in one embodiment, in the step for managing power usage, power to individual ones of the power-using devices is reconnected to primary power as a result of power status changing from a more unreliable status to fully reliable status. Also in one embodiment the interactive interface enables the user to set priority status for the router and for individual ones of the power-using devices, and wherein priority levels are used in determining which power-using devices to shut off or to divert to an alternative power source.

In one embodiment the alternative power source for individual ones of the power-using devices is an internal or closely-coupled rechargeable battery, and in the managing power step the router may cause the power-using device to switch from primary power to battery power, or from battery power to primary power according to primary power status determined, and wherein the battery is recharged while the power-using device is connected to primary power. Also in one embodiment the information regarding the primary power source includes one or more of information derived by the Internet-connected server by monitoring power grids and utility company sites, weather information and information gathered from social networks.

In some embodiments the information is processed by the Internet-connected server to provide power status for different geographical areas, and information pertinent to the geographical area in which the router is located is sent to the router. Also in some embodiments the Internet-connected server executes machine-learning routines to create a further source of power status prediction.

In another aspect of the invention a method is provided comprising steps of implementing a router in a local premise network, the router having a processor, a data repository, wired connection or wireless coupling to individual ones of a plurality of power-using devices in the local premise, the router and the power-using devices drawing power from a primary source, and individual ones of the router and the power-using devices having switchable access to one or more alternative power sources, an Internet access connection, and software executing on the processor from a non-transitory medium, monitoring by the router executing the software power provided by the primary source to the router and to individual ones of the power-using devices, receiving information regarding the primary power source from one or more network-connected servers, determining expected status of the primary power source by the software using the monitoring information and the information received from the Internet, and managing power usage by the router and the power-using devices according to the expected status determined.

In one embodiment of the method, in the step for determining expected status, a status is selected from a plurality of preprogrammed status levels, ranging from reliable power to complete interruption of the primary source. Also in one embodiment the software provides an interactive interface to a user accessing the router through the Internet network or by WIFI connection, enabling the user to configure the functions of the software for power-management activity. Also in one embodiment, in the step for managing power usage, power to individual ones of the power-using devices is shut off or diverted to an alternative power source as a result of status changing from fully reliable primary power to a different status level.

In one embodiment, in the step for managing power usage, power to individual ones of the power-using devices is reconnected to primary power as a result of power status changing from a more unreliable status to fully reliable status. Still in one embodiment the interactive interface enables the user to set priority status for the router and for individual ones of the power-using devices, and wherein priority levels are used in determining which power-using devices to shut off or to divert to an alternative power source. Still in one embodiment the alternative power source for individual ones of the power-using devices is an internal or closely-coupled rechargeable battery, and in the managing power step the router may cause the power-using device to switch from primary power to battery power, or from battery power to primary power according to primary power status determined, and wherein the battery is recharged while the power-using device is connected to primary power.

In some embodiment the information regarding the primary power source includes one or more of information derived by the Internet-connected server by monitoring power grids and utility company sites, weather information and information gathered from social networks. Also in some embodiments the information is processed by the Internet-connected server to provide power status for different geographical areas, and information pertinent to the geographical area in which the router is located is sent to the router. And also in some embodiments the Internet-connected server executes machine-learning routines to create a further source of power status prediction.

### BRIEF DESCRIPTION OF THE SEVERAL VIEWS OF THE DRAWINGS

FIG. 1 is an architecture diagram depicting arrangement of elements in one embodiment of the invention.

FIG. 2 is a process flow chart depicting a process for monitoring for and reporting fluctuations found in an alternating current (AC) line incoming into the power management system.

FIG. 3 is a block diagram depicting a premise network with power management system 108 depicted in more detail according to one embodiment of the present invention.

FIG. 4 is a process flow chart depicting steps for processing collected data for predictive results.

FIG. 5 is a Unified Modeling Language (UML) diagram depicting a statistically predictive data model according to one embodiment of the present invention.

FIG. 6 is a block diagram depicting a power budget model according to an embodiment of the present invention.

### DETAILED DESCRIPTION OF THE INVENTION

In various embodiments described in enabling detail herein, the inventor provides a unique system for managing power consumption for multiple appliances connected to a smart network in a home or business (premises). The present invention is described using the following examples, which may describe more than one relevant embodiment falling within the scope of the invention.

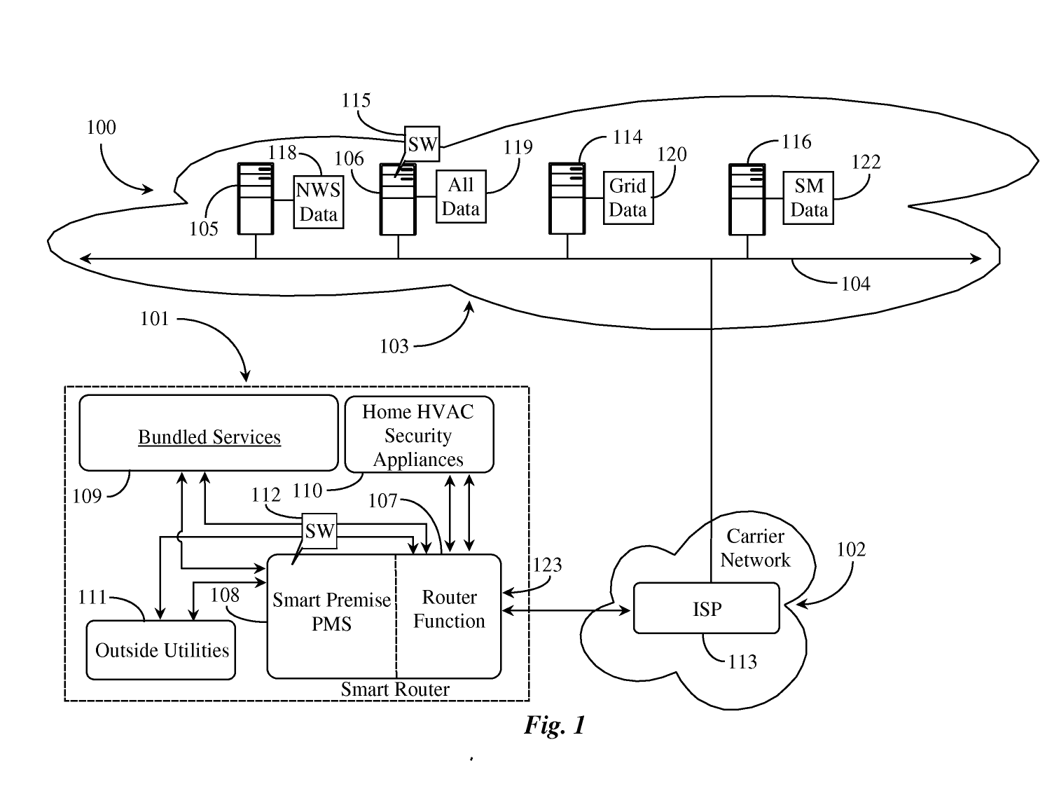

FIG. 1 is an architectural overview 100 of elements in a system providing smart premise power management according to an embodiment of the present invention. The system as shown includes elements in the Internet network 103. Internet network 103 is further characterized by a network backbone 104. Network backbone 104 represents all of the equipment, lines and access points that make up the Internet as a whole including any connected sub-networks. Therefore there are no geographic limitations to the practice of the invention. Internet 103 may be a corporate WAN or a combination of wide area networks without departing from the spirit and scope of the present invention. The inventor illustrates the Internet as a preferred network because of wide public accessibility characteristics.

The system includes a communications carrier network 102, which may be a wireless digital network, such as a cellular telephony carrier network, a wired network such as the publically switched telephone network (PSTN), or a cable network without departing from the spirit and scope of the present invention. Carrier network 102 in this example includes an Internet service provider (ISP) 113, which functions to connect clients to Internet 103 upon request. In this example carrier network 102, with the aid of ISP 113, enables Internet access and communications capability to a smart premise network 101. Smart premise network 101 may be a home-based or enterprise-based wired or wireless network that may be personalized for an owner's needs.

The terminology “smart-home” as is often used with smart networks at local residences should not be taken to limit the invention to residences, and premise is used in this specification as a more general term to indicate that the systems and functions described in various embodiments may service homes, businesses, and networks in other organizations without departing from the spirit and scope of the present invention.

Network 101 includes in this example a smart router 123. Router 123 includes a routing function 107 purposed for receiving digital services from the Internet network and providing same to elements in the local network, and for communicating certain information and data to destinations in the Internet from the local network. Network 101 also includes a grouping of one or more digital communications and entertainment/media services 109, labeled bundled services. Bundled services may include telephone services bundled with television and other media services both passive and interactive. Bundled services 109 may run concurrently and are dependent on router function 107 for communications access and access to service-relative resources such as television broadcast servers, media servers, and other data or media sources that are accessible through the smart router connection to the Internet.

Network 101 further includes one or more appliances and or systems 110 that are connected to router function 107 for communications and control that may be sourced from a remote location. In one embodiment appliances may include heating and air conditioning systems (HVAC), a security and alarm system, and a variety of other appliances that are able to connect to the local network. The networked appliances use router function 107 for remote control and communication in this example. Network 101 further includes one or more outside utilities 111 that may be installed outside the enterprise or residence server by the system. Such outside utilities may include, but are not limited to, security cameras, security lighting, watering systems, energy generating systems, and much more. All of the outside utilities use router function 107 for remote control and communication.

Bundled services 109, appliances and systems 110, and outside utilities 111 all have direct or proxy connections to router function 107 of smart router 123 for communications, media delivery, data delivery, interactive sessions and remote control. In this environment router function 107 handles all of the data traffic between local network 101 and resource providers that are involved in part of the management of one or more smart appliances or systems. It is self-evident that gathering all of the appliance and systems on a single network that communicates through a single router minimizes expense and complexity of managing the local network. However, it is also true that the use of only one router and network provider creates an increased vulnerability for all of the networked appliances and systems to network outage issues and power availability issues that might arise.

In this embodiment a power management system (PMS) 108 is provided in network 101 and integrated with smart router 123 for enabling prediction of and subsequent notification of potential power issues before such issues may arise and cause problems with communications, entertainment, and smart operations relative to networked utilities, and for managing operation states relative to power priorities and alternative power sources. PMS 108 in this example has access to a processor (shared between the routing and power management components), a data repository (internal or external), and coded instructions (software SW) 112 that may be executed on the processor from a non-transitory medium. In one implementation SW 112 running on PMS 108 of smart router 123 monitors the power into the system and records fluctuations and outage events that might occur during power usage.

In one embodiment power fluctuation data recorded by PMS 108 may be supplemented with smart meter data recorded for an electric service company from a meter at the demarcation point between the service and client at the premises. In this aspect, a data line may be provided between the utility smart meter and PMS 108 so that meter data can be dually recorded with AC fluctuations on the AC line incoming into PMS 108. In another variation of this aspect, the client owner of the premises (business or home) may, in place of tapping the local meter, authorize third-party access to energy use records maintained for that premise at a server on the Internet or in a database maintained at the utility company premise.

In one embodiment AC power is the primary source of power for smart router 123 hosting router function 107 and PMS 108, as well as for individual ones of the bundled services, HVAC, outside utilities and security appliances. Also in one embodiment there may be alternative power sources (not illustrated) such as battery power, engine or wind-driven power generators, solar cells, or fuel cells. In this regard router function 107 and PMS 108 may be enabled to continue to operate during a power outage or power degradation event by automatically switching to alternative sources of power. Also many of the communications devices, media entertainment systems, utilities, and so on may be adapted to continue to operate with alternative power sources such as those in the options described above.

Data about power fluctuation events that have been recorded by PMS 108 may in one embodiment be time stamped and geo-tagged using the home or enterprise unique identification or an ID unique to the power management apparatus or smart router 123. This data may be transmitted periodically from PMS 108 through router function 107, through carrier network 102 and ISP 113 to a central Internet-connected server 106. Server 106 includes a processor, at least one data repository, and a memory recording all of the software and instruction for functioning as a central data server capable of sending data to and receiving data from other nodes in the network.

Server 106 may be maintained by a service-providing entity such as the provider of smart router 123 containing PMS 108, or a provider of communications and other smart networking services. There may be more than one central server operating in different geographic regions. A cluster of smart systems that are equipped with PMS 108, either combined with the router hardware or provided separately in one embodiment, may define such geographic regions. Server 106 also has connection to a data repository 119 (All Data). Repository 119 records the power fluctuation data sent from smart premise PMS modules located in the geographic coverage region assigned to the server. There may be more than one server for a region without departing from the spirit and scope of the present invention.

Server 106 executes software (SW) 115 that may be executed on the processor from a non-transitory medium to cause the processor to feed the accumulated power fluctuation data into a learning algorithm that is part of the SW and adapted to recognize developing patterns. The individual data records are time and date-stamped in one embodiment for the purpose of correlating learned fluctuation patterns to dates to determine if such patterns are linked directly or indirectly to time and date. The data records may also be geo-tagged as described above so that discovered patterns may be mapped back to the locations affected by those patterns.

SW 115 has an additional function gathering certain data types from external information servers on the Internet network. SW 115 may cause the server processor to periodically query or otherwise obtain network access to one or more other servers connected to Internet backbone 104 for acquiring additional public data relative to power distribution and management. One such server is represented herein as information server 114. Information server 114 includes a processor, at least one data repository and a memory containing thereon all of the software and instruction for enabling function as an information server. Information server 114 has connection to a data repository 120 (Grid Data) that contains all of the electronic grid data for local and national regions receiving power through one or more electric service providers.

Grid data includes information about power production resources such as power plant locations, capacities, plant maintenance schedules, current output figures, and so forth. Power grid data may also include power line capacities, power line geo-map data, and current power transmission figures for those lines. In one embodiment power cost states may also be included with collected grid data. Grid data about the electronic power grid servicing an area may be used as input along with power fluctuation data from multiple users to further aid in recognizing patterns associated with transmission of, distribution of, and availability of power. Announcements regarding planned outages may also be a part of data monitored and used to send predictive information to local networks. Announcements by utility companies concerning grid breakdowns, power outages in various areas, and planned outages for service or maintenance may also be accessed by server 106 to aid in power status prediction.

Internet backbone 104 further supports a national weather service (NWS) server 105. Server 105 includes a processor, at least one data repository, and a memory containing thereon all of the software and instruction for enabling the function of serving national weather information. Server 105 has connection to a data repository 118 that contains weather data including past, present, and predicted states for specific geographic regions. Server 106 with the aid of SW 115 may regularly poll or query one or more weather information servers to collect information relative to weather patterns and current weather conditions for the region or regions covered by the server.

Weather information may include current and predicted weather conditions, information about upcoming storms, current and predicted temperatures and the like. Server 106 with the aid of SW 115 may use information received or otherwise obtained from server 105 as data input along with AC line fluctuation data, and power grid data, in addition to other information, to further aid in pattern detection and subsequent statistical calculations required to categorize the data and to determine what level of notification (if any) should be relayed back to one or more smart premise systems.

In one embodiment server 106 may query or otherwise monitor and obtain information from one or more social networks relative to comments made about power and weather issues with the aid of SW 115. Users of social media frequently post publicly accessible comments and photos about current weather events (and other happenstance) that may be occurring or that have just occurred and that may be mapped to a specific geographic region or location. Internet backbone 104 supports a social media server 116, representative of many such servers and systems coupled to the Internet. Server 116 includes a processor, at least one data repository coupled thereto and a memory containing thereon all of the software and instruction required to function as a social media server. Server 116 has connection to a data repository 122 containing social media (SM) data relative to user comments or posts about weather or about power outages, etc.

In one embodiment server 105 may query or otherwise obtain data from server 116 about weather conditions and power conditions reported or commented on in posts created by social media users. Server 106 may use this data with the aid of SW 115 as additional input data along with power line fluctuation data, national weather service data, and power grid data to a learning algorithm to establish patterns that may be predicted to with a relatively consistent accuracy.

PMS 108 comprises I/O capability for a network manager, which may be a homeowner in some embodiments, to prioritize power supply for individual ones of power-using devices in the local network. This capability may be, in one embodiment, connection to an appliance with general-purpose computer capability, enabled to provide a manager with an interactive interface. In one embodiment, remote access to PMS 108 is provided through a Web page hosted by the smart router, accessible by an IP Address. After device and service priorities are preset for network 101, PMS 108 receives one or more notifications directly through router function 107 relative to predicted power and bandwidth states. A power management scheme may be used to categorize different alert conditions. For example, if a notification comes in that predicts an elevated probability of scarce power resources, certain power-consuming systems or appliances on the local network may be automatically shut down to conserve power for higher-priority appliances and systems. In the event that alternative power sources other than AC, such as solar, external batteries, fuel-based power generation, etc. are in place, these power sources may be selectively brought into play to continue to operate specific lower-priority systems or appliances.

In one embodiment of the present invention PMS 108 and SW 112, may be implemented separately from router function 107 such as on a processor-based computing appliance that is physically separated from but connected to smart router 123. In another embodiment SW 112 may be implemented on a computing appliance connected to the network such as a desktop computer that may have the highest priority on the network. In one embodiment, a notification or alert may predict a complete power outage. In this case, PMS 108 aided by SW 112 may switch on any alternative source of power, like a generator or a battery panel charged using solar, generator, or another power generating system.

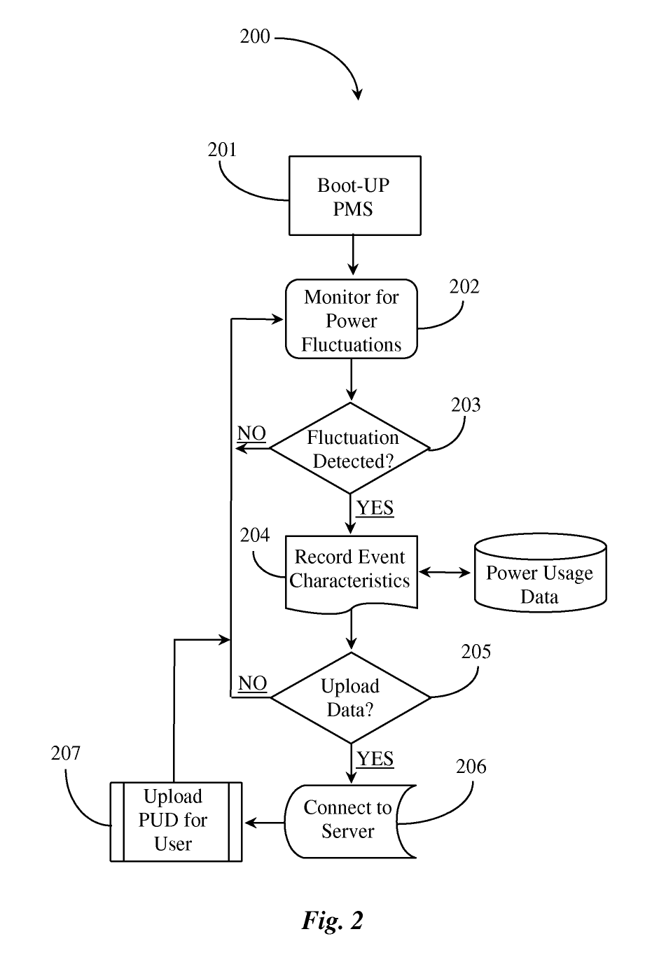

FIG. 2 is a process flow chart depicting a process 200 for monitoring for and reporting fluctuations found in an alternating current (AC) line incoming into the power management system (PMS). Process 200 may be a continual process or a periodically controlled process without departing from the spirit and scope of the invention. Process 200 begins at step 201 where a smart router analogous to router 123 is booted up for use, executing SW 112 on the PMS portion of the router. The smart router containing the PMS hardware and software is connected by default to an AC line for power. However, there may be other power sources available to the router hosting PMS 108 during operation such as solar, gas generated power, wind generated power, and water generated power.

In one embodiment smart router 123 includes one or more power connections to different power sources that might be available for the premise served. By default the PMS may run on AC unless there is an issue where the AC becomes inaccessible or inadequate. At that time, if it is determined to continue operations, the PMS may switch over to an alternative power source. At step 202 the PMS monitors the AC line coming into smart router 123 for power fluctuations including voltage spikes, reductions, and interruptions. In one embodiment, the PMS may monitor more than one AC line coming into the premises if there is more than one line that is serviced by an outside power utility. A power fluctuation may be any amount of power detected on the AC line that varies from the normal voltage reading on that line under normal conditions. Events may include a brown out, a power surge, or a power interruption or disruption.

At step 203 the PMS determines if any fluctuation in power is detected. If no power fluctuations are detected in step 203, the process resolves back to step 202. If the PMS determines that a fluctuation in power has been detected at step 203, the PMS documents the event by logging at step 204. In one embodiment all AC fluctuation events are time-stamped as they are recorded as to the time and date the fluctuation was detected. In one embodiment each record of fluctuation is automatically geo-tagged with the latitude and longitude of the premises network location. Event records may be stored internally in a cache memory or they may be stored in a connected data repository located on the network.

At step 205 in the process the PMS may determine if it needs to upload (offload) data to an Internet server. In one implementation there is a batch number of records defined such that when the batch number of stored records is attained, the PMS uploads the records as a batch of records or data set at step 205. A time period may be associated with the batch of records as a whole, the period defined as beginning at the time stamp of the first record in the batch and ending with the time stamp of the last record in the batch. In a preferred embodiment the individual fluctuation events are organized in a batch by occurrence time and date.

If the PMS determines that it is not necessary to upload data, the process may resolve back to monitoring for power fluctuations at step 202. If the PMS determines that data should be uploaded, the PMS may generate a request for server access at step 206, and may proceed, unless otherwise prevented, to automatically connect to a central server analogous to server 106 described further above. The PMS may use a direct connection through router function 107 to make the connection. In one embodiment the PMS is always connected to the Internet through the router function on smart router 123 and uploads individual power fluctuation records continually as they are detected and time-stamped.

In step 207 the PMS uploads all of the collected data records in batches or otherwise continually each time a fluctuation is detected, confirmed and recorded. The data uploaded from a single premise network is specific to that network alone. Other power-consuming smart premise networks may report their own power fluctuation issues. In this way, a detailed record of power consumption is created for each smart premise network in a geo-grouped cluster or region of smart premise networks. The PMS continues monitoring for all new events over the AC line at step 202 unless it is stopped as a running service, booted down, or re-purposed.

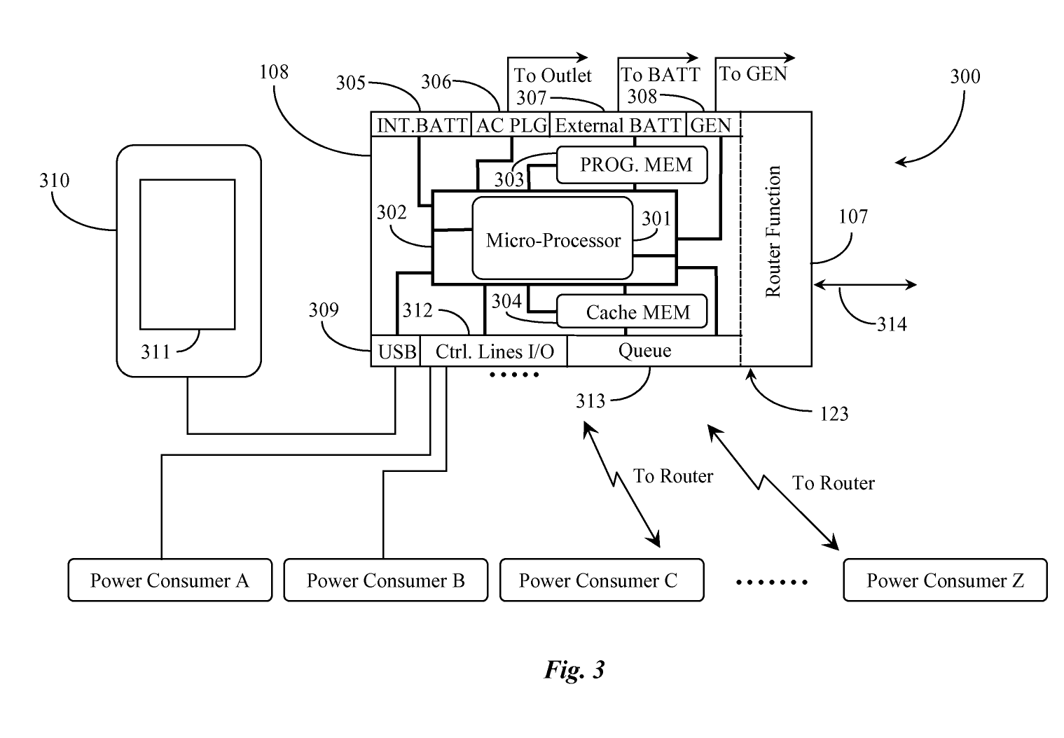

FIG. 3 is a block diagram depicting a network 300 with power management system 108 in more detail according to one embodiment of the present invention. PMS 108 includes a bootable microprocessor or micro controller 301. Processor 301 communicates with other components through a BUS structure 302 illustrated logically herein and for discussion purposes.

Microprocessor 301 has access to a programmable (PROG) memory (MEM) 303. MEM 303 contains all of the coded instruction (SW 112) required to perform power management and ordered prioritization relative to power consumers A-Z that may be active in smart premise network 300. MEM 303 includes a non-volatile memory such as a flash memory or a read-only memory (ROM) including variations thereof. MEM 303 may also include a volatile memory portion such as a random access memory (RAM) or any variation thereof.

In a local premise network, some of power consumers A-Z may be smart devices having an IP address and capable of wireless (or wired) network connection, and for these consumers power management may be done wirelessly from smart router 123 sending data and commands, and power switching and on-off capability may be built in to the smart device. For consumers that do not communicate wirelessly, control lines 312 may be provided to control power settings associated with those power consumers.

Control lines 312 may also be leveraged to control the on/off state of that consumer's network router connection and therefore, access to remote communication on the Internet or on a broader connected network. In another embodiment access to the router channel for a particular power consumer is performed on the smart router in both wired and wireless embodiments. A wireless power consumer that is self powered (internal battery), when connected for communication, may continue to attempt maximum available bandwidth reservation over its network router connection during a low power availability state for the router. In these instances, PMS 108 may shut off router communications for some power consumers but may not attempt to power off the consumer. In such an example, the communication channel may be shut off to conserver remaining available power for the router.

Microprocessor 301 has access to a cache memory (MEM) 304. MEM 304 contains temporary data including activity logs, communication logs, temporary settings, etc. Cache MEM 304 may be a high speed RAM or other MEM type suitable for high speed caching and access to cached data. PMS 108 includes an internal battery (INT BATT) 305 in this example. An internal battery may be used in the event of loss of another power source. Battery 305 may be a rechargeable battery. In one embodiment PMS 108 includes a switch circuitry that automatically switches to internal battery power if no other power source is available due to a power outage.

PMS 108 includes an alternating current (AC) plug (PLG) 306 adapted to accept an AC plug wire leading to an AC outlet. PMS 108 may include in one embodiment, a power interface 307 to an external battery (BATT). An external battery may be one or more batteries charged using solar or another energy generation method such as fuel or wind-generated energy. An external battery source may be shared by other components of the premise network such as by one or more power consumers A-Z. PMS 108 may also have a power interface 308 to a fuel-driven generator (GEN).

In one embodiment switch circuitry (not illustrated) is provided to enable microprocessor 301 to switch over from one source of power to another based on notification of one or more predicted conditions. It is important to note herein that processor 301 may affect switch over from one power source to another based on an actual event that occurs without warning such as unpredictable loss of a source of power currently being drawn by way of act of nature or other accident.

In this embodiment processor 301 may also switch over from one power source to another based on receipt of a notification containing information that causes prioritization of power source selection. In case of an actual loss of power event that occurs without prediction, the switchover is hard-wired and occurs by default. That is to say that the loss of power triggers an automated connection to an alternative power source. One potential use case might be a sudden AC power loss due to an auto accident. The physical loss of power causes the switch to connect to the second power source such as the internal battery.

In one embodiment the unit may be physically altered to cause a second connection to bypass the internal battery in favor of some other power source like an external battery. In one embodiment power sources may be prioritized for default switch over due to an unpredicted loss of power. For example, loss of AC may trigger switchover to internal battery power until the battery is dangerously low. This might trigger default switchover to a next power source like an external battery. When the AC comes back on PMS 108 may automatically switch back to AC power.

In one embodiment PMS 108 may include a universal serial bus (USB) port 309. USB port 309 may be used to communicate via USB cable to a peripheral computing appliance 310 such as an I-Pad with a display 311 and input capability (touch screen). In one embodiment USB port 309 is a wireless USB port or another type of port supporting another type of wireless communications technology such as Bluetooth, infrared, radio frequency (RF), etc.

In one embodiment a premise network owner or service technician may connect appliance 310 to PMS 108 via port 309 to provide new component prioritization instruction, modify existing priority instruction, or to troubleshoot the system. Microprocessor 301 may recognize appliance 310 when plugged into port 309 and powered on and may serve an electronic user interface (UI) stored in MEM 303 for use in interaction with the manageable parts of the system. In another embodiment, a user interface for configuring PMS 108 may be accessible remotely through router function 107 by navigating on the network using a browser interface to the IP address of Router 123.

Smart router 123 includes a queue 313 in one embodiment, for queuing messages including control messages from smart premise network administrators, and alerts or notifications from a central server analogous to server 106 of FIG. 1. Queue 313 may be shared by PMS 108 and router function 107. There may also be separate dedicated queues for each component (router function and PMS).

Queue 313 may be a first-in-first-out (FIFO) queue or a prioritized queue wherein certain alerts or notifications take priority over other routine messages. Such alerts or notifications may be those that inform PMS 108 of a predicted power availability issue. Power alert or notifications may include parameters about the predicted event. The alert or notification may include an event title or an event category such as “power availability alert”. The alert or notification may include the exact nature of the alert. For example, intermittent brownouts predicted for today between 12:00 PM and 5:00 PM. The alert or notification may include a time window or a time to live (TTL) for the alert to be in effect.

Alerts or notifications may be flagged in queue 313 according to one or more levels of priority. An alert table or scheme may be provided that may trigger one or more preset power management states to be initiated by PMS 108. That is to say that the nature of an alert or notification may cause microprocessor 301 of PMS 108 to initiate a preset power management state according to priority settings previously input into PMS by an administrator of network 300.

As an example assume that power consumer A is a media entertainment system and service such as an online interactive gaming system and that power consumer B is an office network connecting an office worker to the Internet. If an alert is received at 9:00 AM warning of a power scarcity with possible interruptions between 12:00 PM and 5:00 PM on the same date, PMS 108 may equate the alert to a preset power management alert level that has been associated or linked to a preset power management configuration. PMS 108 may initiate a power shutdown for Internet gaming system A to begin at 12:00 PM to remain in effect until 5:00 PM, leaving power to consumer B unaffected because of a priority setting. If a total power loss is predicted for AC power, PMS 108 may trigger a switchover to another power source that may be in place at the location.

In one embodiment, power alerts come into PMS 108 via the router function 107 and connection 314 to the Internet network. Such alerts have been generated on a central server like server 106 of FIG. 1 from intelligence from various sources described further above with respect to FIG. 1. Alerts having a same geo-tag indicative of the geographic area covered in an alert are sent to smart premise networks located in those geographic areas. In one embodiment, after the time window associated with an alert has passed, PMS 108 may reset power consumers A-Z back to their pre-alert priority states.

In this example, PMS 108 is hosted on smart router 123 along with routing component 107. However, in an alternative embodiment the functionality of PMS 108 may be implemented in a completely separate hardware and SW on a smart premise network processor with a router connection without departing from the spirit and scope of the present invention. In one embodiment a smart premise network may receive one or more alerts and may initiate a power management priority state affecting one or more power consumers A-Z when no administrator is available or at the location of the network. In such instances PMS 108 may be capable of generating short messages to inform a remote administrator of the activity through the onboard routing function. The administrator may receive such activity notifications in email, on social media pages, on a mobile device, or by automated phone call. In one embodiment, an administrator may intervene and override alert-triggered priority settings on site or from a remote location using a Web-connected communication appliance having a display and a means of data input.

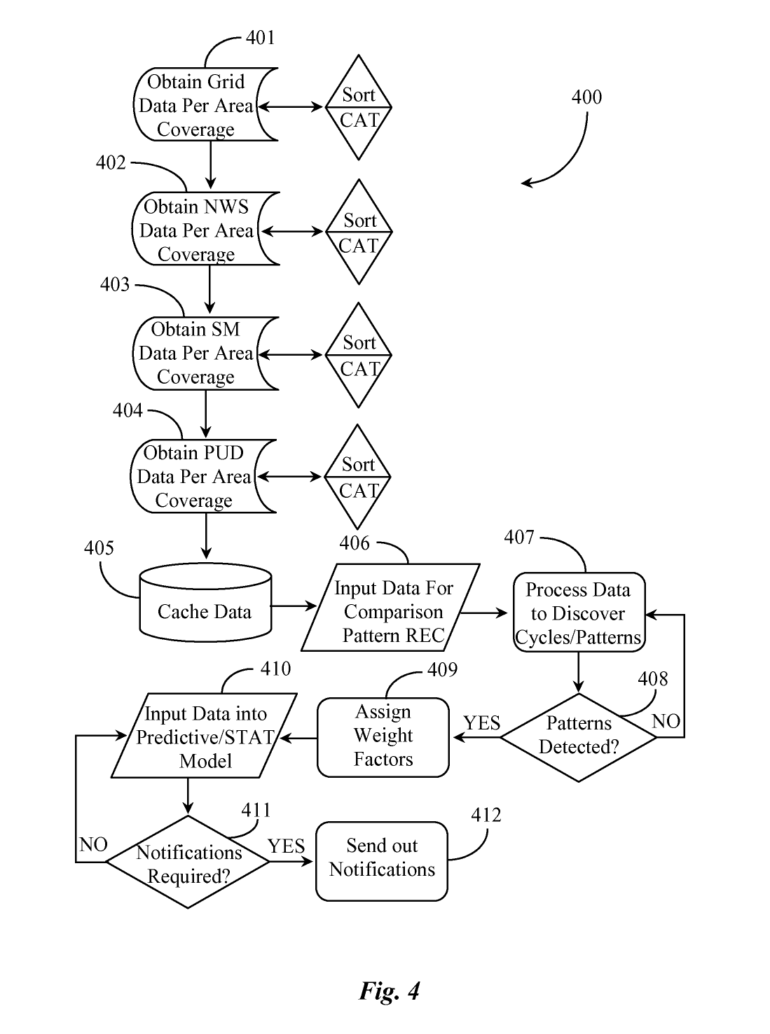

In one embodiment the schedule of the smart premise network administrator is taken into account when creating priority settings for the power consuming appliances and systems. For example, when there will be no one on site, PMS 108 may maintain a lower power management profile, shutting down anything that is not absolutely required and changing power settings for some power consumers such as switching to sleep mode, hibernation, or shutting down the appliance or system altogether during the stated times. FIG. 4 is a process flow chart 400 depicting steps for processing collected data for deriving predictive results. A network-connected server analogous to server 106 of FIG. 1 running SW 115 may obtain, sort, and categorize electric grid data, in accordance with the geographic region assigned for that server from a server associated with public grid information service. Such data might be obtained through a server-to-server query or via screen scrape technologies.

Grid data may include data about electricity generation and delivery, plant maintenance schedules, energy storage points and capacities, transfer line voltage capacities, current grid conditions, and the like. In one embodiment where there are more than one central server servicing clusters of smart premise networks, servers assigned to different regions may send alerts or notifications to one another if some grid data in their own geographic region might directly affect the power availability state of the grid portion corresponding to the region assigned to the other server. Grid data may also include historical or archived data.

Step 401 indicates the server at network level obtaining grid data. At step 402 the server may obtain, sort and categorize national weather service (NWS) data that is relevant to the geographic area covered by that server. NWS data may be obtained via a server-to-server query or via screen scrape technologies. NWS data may include current and predicted weather conditions. Weather data may be categorized according to how the weather conditions might affect power availability. For example, an ice storm may seriously affect power for a given area. Other conditions that may affect power availability may include tornadic storms, hurricanes, lightning storms, fog events, icy rain, flood conditions, high fire danger, solar flare-ups, and so on. NWS data may include historical or archived data.

At step 403 the server may obtain, sort and categorize social media (SM) data posted about weather and power issues for the region assigned to the server. SM data may be obtained via a server-to-server query or via screen scrape technologies. SM data may include posted pictures with captions and comments about current weather and power issues affecting specific locations. SM data may be categorized according to how the posts might contribute to management of power distribution on the smart premise network. For example, a posted picture of a blown transformer may indicate time and location of the incident and might include information about the expected repair time. Such data may be useful in predicting power availability for nearby networks. SM data may include historical or archived data. It is important to note herein that SM data may include posts about current power issues or problems that are not yet documented or known by the electricity service provider.

At step 404, the server may obtain, sort and categorize power usage data (PUD) for smart premise networks in the geographic area or region covered by the server. PUD includes at minimum logged and timestamped power line fluctuation data. PUD may also include supplemental data from an electric utility provider that may be tapped from an electric meter and uploaded with power fluctuation data or that might be accessed later from a network location by the server based on permission of the owner/administrator of a smart premise network. PUD may be categorized by type of fluctuation whether it is a power brownout or complete power interruption, for example. Duration of a continued fluctuation or fluctuation pattern may also be a part of each individual fluctuation record.

The data collected in steps 401 through 404 may be collected simultaneously and on a continual or periodic basis. The data may be cached locally to the server for use as input data into a statistically predictive model (driven by algorithm) at step 405. The cached data is fed into the predictive model for processing in step 406. The model will attempt to recognize and to discover patterns through data comparison of the different data types collected. The data is processed in step 407. Data processing may include analyzing different data types and then comparing them against one another relative to a time frame or time cycle in order to determine if there are any correlating patterns that can be identified.

In one use case example, NWS and power grid data may be compared against SM data and PUD data according to a time line to discover any cause and effect patterns that might tend to be repetitive. At step 408 SW 115 may determine whether any patterns are detected. If no patterns emerge at step 408 then the process may resolve back to step 407. If patterns are detected at step 408 that are repetitive those pattern specifics may be assigned a weight factor in step 409. A weight factor may be assigned according to the predicted relevance of the pattern detected to a potential power availability issue for one or more smart premise networks in the geographic area covered by the server.

The data input at step 406 may be a time-based series of vectors, with each time stamp including a row of data or “features” that may have relevance to power interruption. By recording the input vectors over time, together with the output variable of power status, the central server aided by SW 115 may learn to predict power interruptions through a regression algorithm that fits weighting factors to the input vector. While some functions may be linear, such as the number of keyword tweets in an area, other functions may be non-linear such as seasonal, weekly or daily cycles. Any nonlinear function can be reduced to a series of linear relationships, however, and nonlinear functions also can be fit with modern machine-learning regression tools such as trigfit in Mathematica or equivalent tools such as Python NumPy libraries or languages such as R.

The pre-processed data may be fed into a statistically predictive data model at step 410. In this step, the events defined as patterns and their weights are processed algorithmically to help predict overall power availability for the smart premise networks under control of the server. The result may be expressed as a series of hierarchal alert levels aligned with a period of time, like yellow for 0-30% likelihood of an issue, orange for 30 to 50% likelihood of an issue, and red for a likelihood of an issue above 50%.

A statistically fit predictive model for power interruption may be personalized in one embodiment to a single smart premise network based on unique PUD and other parameters obtained from that network address. For example, an orange alert for two different smart premise networks predicted for a same time window might result in different actions taken to manage power availability at those locations. Variables that trigger different power management actions for each premise network may include user priority preferences, distribution of appliances and systems on each network, and current power capacity at each location relative to alternative power source availability and so on.

The server aided by SW 115 determines at step 411 whether or not notifications need to be generated and sent out to specific smart premise network routers. If it is determined that no notifications are required then the process may resolve back to step 410. If it is determined that notifications are required at step 411, the server generates and sends the notifications out to a pre-determined list of smart premise network router addresses designated to receive the notifications at step 412. A notification to a smart home premise network may, in one embodiment, be generic for a specific geographic area or resolution. For example, an orange alert may be sent to all smart premise networks located in a specific county. At each network, local processing by the PMS may determine what if any automated actions might be undertaken under the circumstances of the notification.

In one embodiment individual smart premise networks include an agent that may be part of SW 112 that, through monitoring power usage, defines usage statistics over time for all of the components connected to and operating on the network and then suggests priority states for those components relative to a hierarchy. This information may be presented upon request from the network administrator and may be useful for the administrator to re-set or confirm preset or suggested priority levels for the components. The agent may also include an interface for adding new appliances and systems (power consumers) to the network.

In one embodiment where a notification of a risk to power availability goes out to a set of smart premise networks, a second notification may be sent out to cancel the previous notification before the TTL for the first notification expires. A reason for this may be that a development has been detected in the data that obfuscates the relevancy of the first notification. Similarly, a notification may be served to smart premise network routers that may override a previous notification (switch from orange to red alert) before the TTL for the previous notification expires.

In a smart premise network, no notifications may mean that power availability predicted for the immediate future is plentiful. In this case wireless and Internet communications bandwidth may be used for entertainment video streaming and games, which may not be the high priority when power is scarce. When a notification predicts a high probability that power may become scarce, the PMS for that network may reserve power for phone communications and home security operation, while suspending power to media and entertainment apparatus.

In one embodiment, PMS may simply regulate which power consumers on the network have access to bandwidth from the router connection. That is to say that a power consumer competing on the network for outside communications may be suspended from its router access but not specifically shut down relative to its power source. For example, a child's laptop that is wirelessly connected and running on internal battery power may be suspended from communicating with the router when the priority state indicates low priority for the power consumer (laptop) and operator (child). The activity of gaming would also be a low priority in a power uncertainty state. Such a suspension may last until conditions change sufficiently to warrant reconnection of the appliance to the router.

In one embodiment users of the smart premise network are identified and their usage statistics collected for the purpose of suggesting general priority states for those users on the network. General priority statistics may be limited to family hierarchy or by actual activity characterization. A mother shopping on an interactive network might have priority over a child playing an Internet game. However, the child might have priority over the Mother shopping if the child is doing homework. A model for priority for power consumption may be suggested to the administrator who may then alter it according to personal preferences. The model may then be used locally to aid the PMS in power switching and mode-setting operations relative to predicted power availability conditions.

Another important consideration in power management is power drain on the router when too many appliances or devices are competing on the network to communicate through the router. Other considerations may be observed and applied relative to power management in a smart premise network such as considering distance of connected appliances and systems are from the router in a wireless embodiment. Power requirement increases proportionally to an increase of the square of the distance in wireless fidelity (WiFi). In one embodiment the router may operate with divided frequencies. The router may also include a combination of wired connections, optical connections, and wireless connections. In some cases lower priority appliances or systems are automatically shut down, limited in their capacity to access services (router connection), or switched to operate on a narrower bandwidth capacity while active on the network.

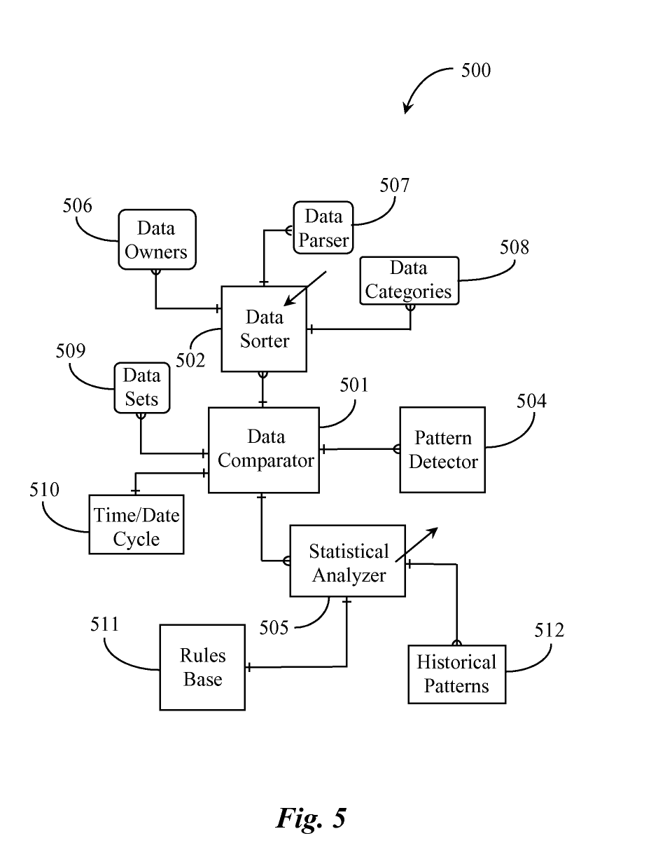

FIG. 5 is a Unified Modeling Language (UML) diagram depicting a statistically predictive data model 500 according to one embodiment of the present invention. Data model 500 may be implemented in SW executing from a transitory medium on a processor of an Internet-connected server analogous to server 106 of FIG. 1 above executing SW 115, or on the processor of the router in the smart premise network. Data input into predictive data model 500 is represented herein by a directional arrow leading into a data sorter 502 representing a first interface to input data collected or aggregated from various sources such as NWS data, Grid data, SM data, PUD, and so on. Data sorter 502 may include one-to-many data parsers 507 adapted to parse incoming raw data for content. In one embodiment a portion of all of the incoming data has been formatted according to at least data source, time stamp for record, media type, and data content.

It is important to note that power usage data (PUD) is power fluctuation data that has been recorded at a location of a smart home premise network in the coverage area of the server. Therefore, predictive model 500 may be personalized at least in operation to a single smart premise network location by combining the unique power fluctuation data relative to a single location with the more general geo-correlative data collected from public interfaces and other sources.

Data sorter 502 may further organize parsed data into one-to-many data categories 508. Data sorter 502 may sort data according to data owners or sources 506 representing more abstract data categories. Data categories 508 may, in one embodiment, be data sub categories organized beneath sets of records belonging to one or many data owners 506. For example, a data owner may be the Utility Grid and a data sub category 508 might be notification of a planned power shutdown for maintenance. Another data owner 506 may be the NWS and a data subcategory might be a storm prediction.

Model 500 includes a data comparator 501. Data comparator 501 receives pre-formatted data input from data sorter 502. The preformatted input may be formatted in a machine language suitable for the purpose. Comparator 501 may run comparison operations using one or more data sets 509. Comparator 501 may apply a time and date cycle 510 when comparing data sets, which contain time-stamped and dated records for comparison. When comparing different data sets 509, data comparator 501 may enlist one-to-many pattern detectors 504 to detect and record any correlation or patterns within the compared data sets. A pattern or correlation between compared data sets might be a scheduled plant shutdown on the Grid corresponds to a subsequent cluster of brown outs identified from geo-local PUD collected from local smart home premises on a substantially repetitive time and date cycle.

Model 500 includes a statistical analyzer 505. Statistical analyzer 505 receives input data from data comparator 501 in the form of records of detected patterns learned or discovered from previous data analysis. Statistical analyzer 505 is adapted to provide statistical probabilities of a pre-specified condition occurring during a specific time window or time cycle in the future. A time cycle may be defined as a cycle of repetitive time periods that are the same, for example 24 hours followed by another 24 hours. A time window may be a customized period of time defining the period for which the statistically higher likelihood of a power condition arising might be present. In one embodiment individual premise administrators might create and apply specific time windows for observing a predicted alert, the time windows also defining the amount of time for switchover to pre-prioritized power settings for the network.

Pre-prioritized power settings may be governed in part or in whole according to a power budget model created for each smart premise network. A power budget model (PBM) for a smart premise network might be created in a generic sense by a service provider at a central location analogous to server 106 executing SW 115 of FIG. 1. An administrator for a particular smart premise network may then access or obtain by download a generic version of the model and customize the model using a remote or a local appliance interface. A PBM may include power usage data about power consumers connected to the network and capacity and cost data about the primary and other power sources that are locally available to the smart premise network.

Statistical analyzer 505 may access a rules base 511 when applying statistics probability assessments to a specific pattern detected. One rule may enforce certain weight factors to be applied to certain types of patterns analyzed or the frequency of repetition “pattern integrity” of the pattern. Rules may be self-learning rules that may evolve mathematically according to historical results of accuracy of past predictions. Such a feedback loop aids in fine-tuning the rules to sharpen accuracy of future predictions.

Statistical analyzer 505 may access a historical pattern archive 512 to obtain previously predicted patterns and actual results for the purpose of refining the accuracy of the prediction. In a percentage-based system the accuracy of the prediction might be implied by the statistical probability associated with the prediction. For example, an orange alert for brownout might be triggered for a probability range above 40% but below 60%. A red alert for the same issue might be triggered if the statistical likelihood applied to the prediction were above 60%.

Initial statistical results of statistical analyzer 505 may be refined more than one time before final output without departing from the spirit and scope of the present invention. In this example, a first statistical result applied after consulting the rules base may be further refined after consulting historical patterns and actual results. For example, a statistical probability might be derived and may trigger an alert warning of the probability of a specific type of power issue event occurring at a specified level of alert for one or more smart premise networks. After further refinement of the data, another statistical probability might be derived for predicting the duration (short, long) of the expected event and whether or not the event might have a repetitive occurrence pattern such as cycling every x period of time. An overall statistical weight (predictive success rate) might be associated to the correlation of actual power issue results to past power issue predictions within the system. Other output refinement algorithms or filters may also be used and included herein without departing from the spirit and scope of the present invention.

Output from model 500 is illustrated herein as a directional arrow emanating from statistical analyzer 505. Such output may be formatted in machine notification language according to an existing machine language, a model description language such as extensible markup language (XML) or a derivative or variation thereof. The data output from model 500 may be input into an alert or notification interface that has access to a predefined table containing alert levels for different types of power issues. During notification, which is not illustrated in the model, the incoming messages from statistical analyzer 505 are equated to the appropriate notification or alert type, which may then be generated and sent to affected premise networks under geographic coverage of the server.

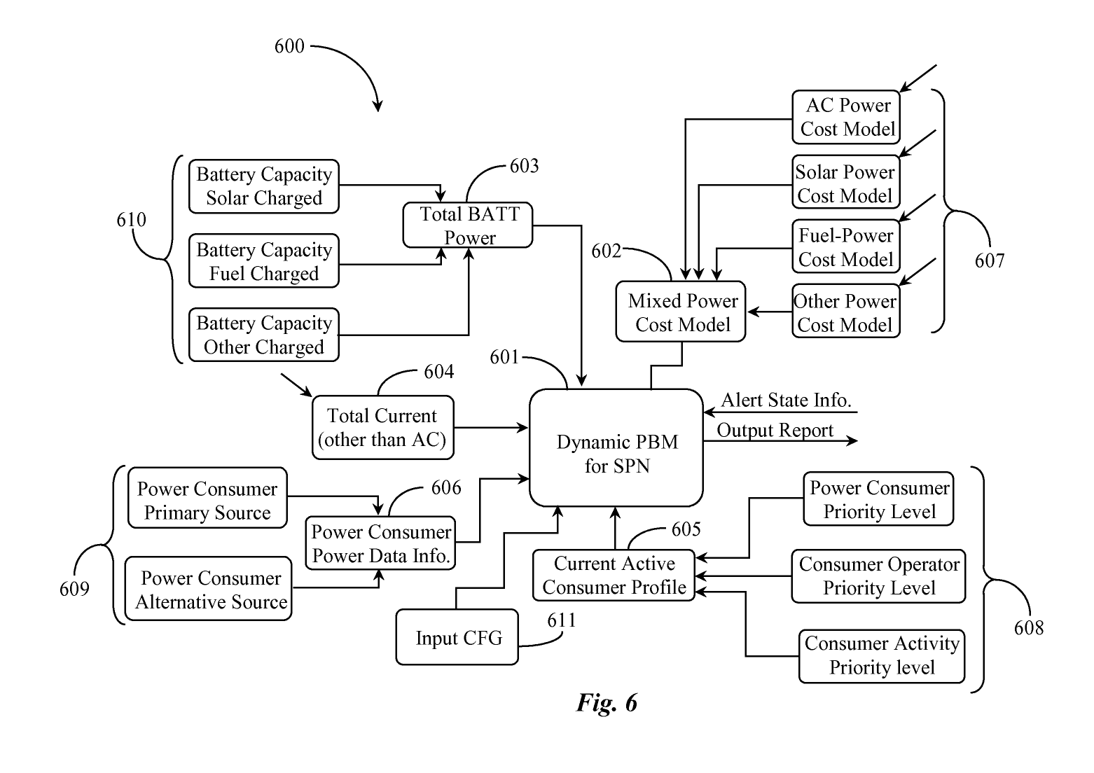

FIG. 6 is a block diagram illustrating a power budget model 600 according to an embodiment of the present invention. Power budget model (PBM) 600 includes a dynamic core data model 601 that retains all of the current data representing an active power state of a smart premise network. A PBM for a smart premise network (SPN) may evolve according to multiple factors related to current local power issues, cost of power, profile of networked power consumers, administrator-ordered priorities, and so on. In one embodiment, SW 112 of FIG. 1 retains a current most-updated version of a PBM custom for a specific SPN. PBM 600 is a dynamically changing model. As inputs change in value over time, the model adapts and may evolve to present different model views (data views) according to different conditions actual or predictive.

Core PBM module 601 receives updates relative to costs of using primary power from the power grid and costs of using alternative power sources separate from or in combination with AC. Updated information may be communicated to core PBM 601 from remote data sources through the smart router function. Power cost models 607 are dedicated cost models reflecting the latest calculated costs associated with usage of each of the separate power sources. For example, an AC power cost model represents the most updated information about what it is costing the administrator of a SPN to use AC to power the consumer nodes on the network.

A solar power cost model 607 represents the latest information associated with what it costs to use solar power to power the consumer nodes on the network. A fuel power cost model 607 represents the latest information associated with what it costs to use fuel generated power to power the consumer nodes on the network. Other power cost model 607 represents a cost model for any other source of power other than those illustrated herein. Essentially, the power budget model (PBM) is a function of how much energy we can store, how much we can capture from other sources, and how much we consume safely over a predicted period of time.

In one embodiment a particular SPN may have more than one power source that is contributing to an overall power usage equation. Therefore, during any particular power issue state core module 601 may be updated with an active mixed power cost model 602 representing average cost for mixed use of more than one power source. It is important to state herein that a wireless device that has an internal power supply and that is registered for use on the network may still be managed relative to an overall power usage scheme for a network. For example in the event of total loss of power such mobile devices may still function so knowledge about the battery capacities of those devices may be leveraged in certain power states. Furthermore, internal batteries must be charged or maintained at a charged state, which draws upon primary and perhaps other power sources available to the network.

Battery capacity profiles 610 represent total capacities for batteries charged by a specific power source. To attempt to operate the SPN within general and more conditional power budget guidelines or priorities, separate and total battery capacities that might contribute to an overall power use profile are accounted for in the model. In this example there is a battery or batteries charged using a solar system; a battery or batteries charged using a fuel generator or fuel cell-based technology; and a battery or batteries designated as charged by “other” power source, which could be any source other than those already illustrated. In one embodiment, a bank of batteries may be charged using more than one power source simultaneously without departing from the spirit and scope of the present invention.

Total BATT power profile 603 represents the accumulated data for batteries charged by all of the non-primary power sources. Profile 603, much like any battery charge state information, may change dynamically as power sources like batteries are tapped and used and subsequently recharged. In one embodiment, alternative power sources like solar or a fuel generator may contribute directly to power needs in certain power states of the SPN. Total current profile 604 retains the total amount of available current other than AC that may be directly produced and used without considering storage.

PBM core 601 also receives updated information about the power source types used by all of the power consumers on the network. Power consumer profiles 609 reflect individual power consumers and their power source assignments. Some consumers may be assigned to an alternative power source a primary power source or to a prioritized setting including a primary and one or more alternative power sources. Moreover, power source assignments may be dynamically changed for a power consumer according to any power issue alerts or notification received by the PMS. Power consumer power data information profile 606 represents an accumulation of the individual profile data for each networked consumer.

PBM core 601 may also access local priority settings created by a network administrator. Priority settings 608 include power consumer priority assignments for each power consumer relative to another. It is noted herein that there may be more than one priority assignment for one power consumer dependant upon condition of the power availability to the network. When there is no condition and primary AC power is abundant then priority of operation may not be an issue as all power consumers may operate simultaneously according to network capacities. However, when an alert or notification causes power conversation procedures to occur, priority of power consumer is taken into account.

Other priority settings 608 include power consumer operator priority or the importance level of whom in a family is currently operating a power consumer on the network. For example, during a power availability-warning period, an operator's priority might be tied to which power consumers will be allowed to continue operations and communications on the network. If there are two power consumer operators, an adult operating a workstation, and a child operating a connected game station, then the adult may continue with communications uninterrupted while the child has Internet communications shut down for the station to conserve power for the router. Another priority setting may be activity pursued on the power consumer. Like adult vs child, activities pursued on the network may retain priority over others in certain power-availability states of the network. Current active consumer profile 605 represents an accumulation of the individual priority settings for power consumers, operators, and activities to produce a network profile snapshot of prioritized power usage.

In one embodiment a network administrator may partially configure PBM 600 through an input configuration interface 611. PBM may be configured locally using a network appliance plugged into an input port on the smart router. In one embodiment the configuration might be accomplished remotely through the router connection to the broader network. SW 112 may consult PBM 600 for an optimized picture of the actual power availability states and conditions facing the network before initiating any changes to power assignments and network operational priorities under limited power availability conditions. The PBM model depicts the current power and operational states of an SPN at any given time and under changing conditions.

In one embodiment the model changes according to a constant push toward lowering the overall power costs associated with the network operation on a daily basis. For example, if solar generated power becomes cheaper than fuel generated power, then the first toggle would be solar if there were a power issue. In consulting with the model, SW 112 may run different scenarios in order to attempt to find a network state that saves the most power and that still accomplishes the desired functionality of the network for the network owner or administrator.

In use, the system relies on the predictive model of FIG. 5 and on the power budget model illustrated herein to optimize network efficiency under stress of power uncertainty or complete unavailability. As the system self learns patterns and results through appropriate feedback mechanisms or loops, the system makes more accurate and granular predictions. For example, the system might predict a power availability uncertainty state for a specific period of time for a small geographic area of SPNs and further that the actual power interruption may be a short term interruption rather than a long term interruption, or that there could be several short interruptions within this period. The power management system automatically prioritizes network settings including power and communications settings under actual and predicted power availability conditions.

It will be apparent to one with skill in the art of machine learning that the system of the present invention may continue to evolve as more data is processed and as changes occur due to infrastructure additions, dam removals, or other more general developments related to the entire infrastructure as a whole.

It will also be apparent to the skilled person that the arrangement of elements and functionality for the invention is described in different embodiments in which each is exemplary of an implementation of the invention. These exemplary descriptions do not preclude other implementations and use cases not described in detail. The elements and functions may vary, as there are a variety of ways the hardware may be implemented and in which the software may be provided within the scope of the invention. The invention is limited only by the breadth of the claims below.

1. A router, comprising:
a processor;
a data repository;
wired connection or wireless coupling to individual ones of a plurality of power-using devices in a local premise, the router and the power-using devices drawing power from a primary source, and individual ones of the router and the power-using devices having switchable access to one or more alternative power sources;
an Internet access connection; and
software executing on the processor from a non-transitory medium, execution of the software providing:
monitoring power provided by the primary source to the router and to individual ones of the power-using devices;
receiving information regarding the primary power source from one or more network-connected servers;
determining expected status of the primary power source by the software using the monitoring information and the information received from the Internet; and
managing power usage by the router and the power-using devices according to the expected status determined.

2. The router of claim 1 wherein, in the step for determining expected status, a status is selected from a plurality of preprogrammed status levels, ranging from reliable power to complete interruption of the primary source.

3. The router of claim 1 wherein the software provides an interactive interface to a user accessing the router through the Internet network or by WIFI connection, enabling the user to configure the functions of the software for power-management activity.

4. The router of claim 1 wherein, in the step for managing power usage, power to individual ones of the power-using devices is shut off or diverted to an alternative power source as a result of status changing from fully reliable primary power to a different status level.

5. The router of claim 1 wherein, in the step for managing power usage, power to individual ones of the power-using devices is reconnected to primary power as a result of power status changing from a more unreliable status to fully reliable status.

6. The router of claim 3 wherein the interactive interface enables the user to set priority status for the router and for individual ones of the power-using devices, and wherein priority levels are used in determining which power-using devices to shut off or to divert to an alternative power source.

7. The router of claim 1 wherein the alternative power source for individual ones of the power-using devices is an internal or closely-coupled rechargeable battery, and in the managing power step the router may cause the power-using device to switch from primary power to battery power, or from battery power to primary power according to primary power status determined, and wherein the battery is recharged while the power-using device is connected to primary power.

8. The router of claim 1 wherein the information regarding the primary power source includes one or more of information derived by the Internet-connected server by monitoring power grids and utility company sites, weather information and information gathered from social networks.

9. The router of claim 8 wherein the information is processed by the Internet-connected server to provide power status for different geographical areas, and information pertinent to the geographical area in which the router is located is sent to the router.

10. The router of claim 9 wherein the Internet-connected server executes machine-learning routines to create a further source of power status prediction.

11. A method comprising steps:
implementing a router in a local premise network, the router having a processor, a data repository, wired connection or wireless coupling to individual ones of a plurality of power-using devices in the local premise, the router and the power-using devices drawing power from a primary source, and individual ones of the router and the power-using devices having switchable access to one or more alternative power sources, an Internet access connection, and software executing on the processor from a non-transitory medium;
monitoring by the router executing the software power provided by the primary source to the router and to individual ones of the power-using devices;
receiving information regarding the primary power source from one or more network-connected servers;
determining expected status of the primary power source by the software using the monitoring information and the information received from the Internet; and
managing power usage by the router and the power-using devices according to the expected status determined.

12. The method of claim 11 wherein, in the step for determining expected status, a status is selected from a plurality of preprogrammed status levels, ranging from reliable power to complete interruption of the primary source.

13. The method of claim 11 wherein the software provides an interactive interface to a user accessing the router through the Internet network or by WIFI connection, enabling the user to configure the functions of the software for power-management activity.

14. The method of claim 11 wherein, in the step for managing power usage, power to individual ones of the power-using devices is shut off or diverted to an alternative power source as a result of status changing from fully reliable primary power to a different status level.

15. The method of claim 11 wherein, in the step for managing power usage, power to individual ones of the power-using devices is reconnected to primary power as a result of power status changing from a more unreliable status to fully reliable status.

16. The method of claim 13 wherein the interactive interface enables the user to set priority status for the router and for individual ones of the power-using devices, and wherein priority levels are used in determining which power-using devices to shut off or to divert to an alternative power source.

17. The method of claim 11 wherein the alternative power source for individual ones of the power-using devices is an internal or closely-coupled rechargeable battery, and in the managing power step the router may cause the power-using device to switch from primary power to battery power, or from battery power to primary power according to primary power status determined, and wherein the battery is recharged while the power-using device is connected to primary power.

18. The method of claim 11 wherein the information regarding the primary power source includes one or more of information derived by the Internet-connected server by monitoring power grids and utility company sites, weather information and information gathered from social networks.

19. The method of claim 18 wherein the information is processed by the Internet-connected server to provide power status for different geographical areas, and information pertinent to the geographical area in which the router is located is sent to the router.

20. The method of claim 19 wherein the Internet-connected server executes machine-learning routines to create a further source of power status prediction.
